(19) United States
(12) Patent Application Publication
(10) Pub. No.: US 2017/0267586 A1
(43) Pub. Date: Sep. 21, 2017

(54) SUPPLEMENTARY CEMENTITOUS MATERIAL MADE OF ALUMINIUM SILICATE AND DOLOMITE

(71) Applicant: HEIDELBERGCEMENT AG, HEIDELBERG (DE)

(72) Inventors: FRANK BULLERJAHN, LEIMEN (DE); MACIEJ ZAJAC, HEIDELBERG (DE); DOMINIK NIED, PHILIPPSBURG (DE)

(21) Appl. No.: 15/528,638

(22) PCT Filed: Nov. 17, 2015
(86) PCT No.: PCT/EP2015/002549

§ 371 Date: May 22, 2017

(30) Foreign Application Priority Data
Nov. 24, 2014 (EP) 14003967.8

(51) Int. Cl. C04B 28/10; C04B 28/18

(52) U.S. Cl. CPC C04B 28/105; C04B 28/18; C04B 28/184

(57) ABSTRACT

A method for producing a supplementary cementitious material (SCM) that includes providing a starting material containing dolomite and aluminium silicate, converting the starting material to the supplementary cementitious material by burning in the temperature range of >800 to 1100° C. or by burning in the temperature range of 725 to 950° C. in the presence of a mineralizer and cooling the supplementary cementitious material.

The present invention relates to the production of a novel pozzolanic or latent hydraulic supplementary cementitious material, also abbreviated SCM in the following, and binders which contain said material mixed with cement, in particular Portland cement.

Cement, and in this case especially Portland cement, abbreviated OPC (ordinary Portland cement) in the following, is an important construction material on the one hand, but one that requires large amounts of energy and mineral raw materials to produce on the other hand. Hence there have been efforts for some time to reduce the energy and raw material needs, for example by using by-products and waste products.

Substituting Portland cement clinkers with SCMs is especially well-suited for achieving these goals. On the one hand, SCMs are frequently by-products and waste products and therefore reduce the raw material input. The most commonly used SCMs include granulated blast furnace slag and fly ash. On the other hand, lowering the clinker content in turn lowers the energy requirement for the production thereof, because SCMs require less energy to produce than clinkers.

However, by no means all by-products and waste products are suitable as SCMs. The pozzolanic or latent hydraulic reactivity may not be too low, as otherwise the properties of the construction material created from the cement and SCM will be negatively impacted. For example, calcined clay can only be used as an SCM if it has a high mineralogical purity; ideally consists of only one clay mineral. The aluminium oxide content and the Al₂O₃/SiO₂ ratio should be high. Moreover, activation by calcination requires staying within a narrow temperature window as well as the shortest possible calcination times (down to seconds). Because clay is highly absorptive and very fine, a large volume of water reducing agent is needed for concrete made out of cement and such an SCM in order to compensate for the increased water demand. Admixtures can be ad- and absorbed on the surface and in the clay interlayers, respectively, which makes it necessary to use larger amounts.

High-quality clays consisting of a few or only one phase are rare in actual practice and therefore too expensive because of the competition with other industry branches. However, with mixtures it is difficult to set an optimum calcination temperature, or to put it another way, the different optimum temperatures for different constituents make it impossible to activate the entire starting material. If the temperature is too low, insufficient volumes will be activated. At somewhat higher temperatures, only those phases that react at these lower temperatures will be activated, which in most cases is still too low a fraction. Although a sufficient fraction will generally be activated at medium temperatures, some fractions of the starting material will have already formed crystalline and therefore inert phases. Although (nearly) all fractions of the starting material will be activated at high temperatures, most fractions will have already formed inert crystalline phases. The various clay minerals have the following optimum calcination temperatures:
Serpentinite 400-500° C.,
Palygorskite 600-800° C.,
Kaolinite 600-800° C.,
Halloysite 600-800° C.,
Pyrophyllite 750-950° C.,
Montmorillonite 800-950° C.,
Illite 800-1000° C.,
Mica 650-1000° C.
   Non-converted phases have an especially high water demand and therefore must be avoided as much as possible. Many starting materials also have too low an Al₂O₃ content, but considerable amounts of SiO₂ and other constituents such as Fe₂O₃, CaO, MgO, Na₂O and K₂O. For these reasons, many clays cannot be used economically and in certain circumstances clay-containing or clay-rich materials therefore have to be dumped.

It has already been proposed to make such clays usable as SCMs by treating them hydrothermally or by calcining them mixed with limestone or by combining them with limestone; see for example EP 2 253 600 A1 and U.S. Pat. No. 5,626,665. In Tobias Danner's doctoral thesis, “Reactivity of calcined clays”, ISBN 978-82-471-4553-1, it was demonstrated that limestone already present in the starting material or added thereto before burning does not have any influence on the reactivity of the calcined material. It was furthermore established in this study that the material with the highest MgO content originating from magnesium silicate compounds (i.e. not from magnesium carbonate or dolomite to dolomitic limestone) could not be sufficiently activated in order to be used as SCM, in other words had the lowest pozzolanic reactivity. This study also showed that the lime binding capacity (in other words the pozzolanic reactivity) of the materials studied reaches its maximum at burning temperatures of 700 to 800° C. and that even at temperatures slightly above 800° C., e.g., 850° C., the material loses a substantial amount of reactivity. In other words, higher temperatures led to materials with only very low to even no reactivity at all. Consequently, this method was unable to solve the problems associated with clays with mixed phases, which require very different calcination temperatures. The study furthermore did not reveal any positive effect of the dolomite present in minute concentrations, as the latter had not been added in sufficient quantities and the burning temperatures used were also too low. From this study, a person skilled in the art cannot infer a synergistic effect of the calcination of dolomite to dolomitic limestone in combination with a clay, nor a use of the material thus obtained as an SCM.

Dolomite is another material that cannot be used for cement clinker production, nor as an SCM. MgO can only be incorporated in Portland clinkers in a concentration of up to a few percent; a fraction in excess of that is present in the raw meal as “dead-burned” MgO after burning. Such MgO reacts very slowly, to a large extent years later, with water, but then forms Mg(OH)₂, which has a larger volume than MgO and thus destroys the hardened cement. Nor may dolomite be used as an SCM in every case because it partially dissolves, thus releasing CO₂ and forming Mg(OH)₂ under certain circumstances. The CO₂ in turn forms calcite from Ca²⁺. These reactions likewise lead to a volume change, which can in turn lead to crack formation and destruction of the hardened cement.

An approach for rendering dolomite (and limestone) useful is a burning for direct use as air hardening lime/caustic lime/slaked lime or as a hydraulic binder, e.g. as so-called Roman cement. Various authors have studied the reaction products of calcination of clays with a lime or dolomite content or of mixtures of clay and limestone and/or dolomite, but only with a view towards a use of the products as a hydraulic binder or the production of ceramics. See A. L. Burwell, Mineral Report 28 in “The Henryhouse Marlstone in the Lawrence Uplift, Pontotoc County, Okla. and its Commercial Possibilities” and M. J. Trindade et al., “Mineralogical transformations of calcareous rich clays with firing: A comparative study between calcite and dolomite rich clays from Algarve, Portugal”, Applied Clay Science 42, (2009), pp. 345-355. A suitability as SCM is not addressed in these works, and comparative studies have furthermore shown that it is not practical for the majority of the products.

Another study on rendering low-quality clay material useful as SCM also involves an MgO-rich raw material that contains dolomite in traces, see G. Habert, “Clay content of argillites: Influence on cement based mortars”, Applied Clay Science 43 (2009) 322. The predominant MgO fraction is not bound in the dolomite, but present in the form of clay minerals (palygorskite and montmorillonite: Σ69%). Only a small calculated fraction of less than 1% MgO may be present as carbonate, which corresponds to a maximum amount of 5% pure dolomite. The study also shows that burning temperatures above 800° C. lead to a substantial reduction of reactivity, or rather that the material was only present as an inert filler afterwards.

Another study (I. Barbane et al. 2013, “Low-temperature Hydraulic Binders for Restoration Needs”, Material Science and Applied Chemistry, Vol. 28) describes the production and the material properties of a hydraulic limestone based on dolomite and clay. The aim is to produce a system with a maximum amount of dolomite and the lowest possible clay contents. The strengthening reaction is mainly attributed to the hydration of CaO and MgO for conversion to Ca(OH)₂ and Mg(OH)₂, and also, but to a lesser extent, to a pozzolanic reaction. According to this document, higher clay contents ahd correspondingly lower dolomite or limestone contents are not sought, as this would lead to reduced strength development. A combination with, say, OPC is neither indicated nor apparent to be advantageous for a person skilled in the art because, for example, the hydration of OPC already produces large quantities of Ca(OH)₂.

Another study (L. Lindina et al. 2006, “Formation of calcium containing minerals in the low temperature dolomite ceramics”, Conference on Silicate Materials, Materials Science and Engineering, Vol. 25) describes the production and use of a hydraulic binder based on natural mixtures of limestone, dolomite, and clay. The study shows that the optimum burning temperature is around 750° C. Reactivity is substantially reduced even at 800° C. For a person skilled in the art, this leads to the conclusion that burning temperatures lower than 800° C. should be sought. A combination with, say, OPC is neither indicated nor apparent to be advantageous for a person skilled in the art.

In the studies cited, use is made of mixtures with the biggest possible quantity (at least more than 70%, typically more than 80%) of limestone or in rare cases dolomite and only small quantities (less than 30%, typically less than 20%) of clay material. The material produced according to these methods does not lead to an improvement in strength development in combinations with OPC.

EP 397 963 A1 describes hydraulic binders made from burnt oil shale, which are activated by at least one compound chosen from the group consisting of:
at least one oxide of 3- and/or 4-valent cations,
an amorphous hydroxide of 3- and/or 4-valent cations, and
an aluminate of 1- and/or 2-valent cations,
   and contain at least one water-reducing agent. GB 1438 discloses the production of an SCM by burning clay mixed with limestone, lime, dolomite, magnesite, meadow chalk, or marl at temperatures of around 800° C. but below the sintering temperature, with addition of a flux agent such as calcium chloride. The product absolutely must not be sintered, only CO₂ is to be expelled, and it hardens when mixed with lime.

Also other natural and synthetic materials which, like pozzolans, contain aluminium silicate, show a pozzolanic activity that is (too) low for use as SCM.

Hence there is still a need of materials and/or methods for activating aluminium silicates, in particular clay and clay-containing materials and other materials of low pozzolanic quality, in order to render them suitable as SCMs.

Surprisingly, it has now been found that reactive SCMs can be obtained also from inferior quality clay, clay-containing material, and pozzolans that are either poorly suited or not suited for other purposes by burning them in combination with dolomite or magnesium carbonate-containing materials.

The invention thus achieves the aforementioned object through a method of producing supplementary cementitious material in which a starting material, which contains an aluminium silicate constituent and a dolomite constituent, is provided and burned in the temperature range from more than 800° C. up to a maximum of 1100° C. The object is furthermore achieved by a binder that contains cement and the supplementary cementitious material according to the invention.

According to the invention, a reactive SCM is obtained from aluminium silicate and dolomite such that high quality materials can be even further improved on the one hand, and as a particular advantage, materials that are otherwise unusable or only usable with difficulty can be advantageously exploited. The starting material is either provided naturally or created in a targeted manner by mixing and optionally combined grinding, burned in the temperature range of >800 to 1100° C., cooled, and optionally ground.

In order to simplify the further description, the following standard cement industry abbreviations are used: H—H₂O, C—CaO, A—Al₂O₃, F—Fe₂O₃, M—MgO, S—SiO₂ und $—SO₃. Furthermore, compounds will in most cases be listed in their pure form, without explicit mention of solid solution series/substitution by foreign ions, etc., as is normally the case in technical and industrial materials. As any person skilled in the art understands, the composition of the phases mentioned by name in this invention can vary due to substitution with diverse foreign ions, depending on the chemistry of the starting material and the type of production, wherein such compounds are also the subject of this invention and, unless stated otherwise, are encompassed by the phases mentioned in pure form.

Unless stated otherwise, “reactive” means hydraulic, latent hydraulic, or pozzolanic reactivity. A material is hydraulically reactive if it hardens by hydration in finely ground form after being mixed with water, the hardened product retaining its strength and durability in air and under water. A material possesses latent hydraulic reactivity if it is capable of hardening hydraulically after being mixed with water, but which requires activation for a conversion to take place within a technological and/or economically useful time period. A material is pozzolanically reactive if, after being mixed with water at room temperature, it can only harden if an activator, e.g., an alkaline hydroxide or calcium hydroxide, is added. OH⁻ acts on the Al₂O₃—SiO₂ network in such a way that bonds between oxygen and network atoms are broken, giving rise to calcium silicate hydrates (C—S—H) or calcium aluminate hydrates (C-A-H) as strength forming phases. Because many materials have both types of reactivity, a sharp distinction between latent hydraulic and pozzolanic reactivity is often not made.

In the context of this invention, clinker means a sintering product which is obtained by burning a starting material at elevated temperature and which contains at least one hydraulically reactive phase. Burning means activation through changes in one or several of the properties of chemistry, crystallinity, phase composition, three dimensional array and binding behaviour of the structural atoms induced by applying thermal energy. In isolated cases the starting material can also be a single raw material if the latter contains all desired substances in the right proportion, but this is an exception. The starting material can also contain mineralisers. Substances that act as flux agents and/or lower the temperature, which is necessary for forming a melt, and/or substances that catalyse the formation of the clinker compound, for instance through mixed crystal formation and/or phase stabilization, are known as mineralisers. Mineralisers may be contained in the starting material as constituents or selectively added thereto.

A clinker ground with or without other constituents added, and also other hydraulically hardening materials and mixtures including, but not limited to supersulphated cement, geopolymer cement, and belite cement obtained by hydrothermal conversion, are designated as “cement”. A material that hardens hydraulically upon contact with water and that contains cement and typically, but not necessarily, other finely ground constituents is known as a binder or binder mixture. The binder is used after adding water, and usually also aggregates and optionally additives.

A pozzolanic and/or latent hydraulic material that replaces at least a portion of the clinker in a cement or binder is referred to as a supplementary cementitious material or SCM. Latent hydraulic materials have a composition that enables a hydraulic hardening upon contact with water, wherein an activator is typically necessary for a hardening within technologically useful time periods. A material that accelerates the hardening of latent hydraulic materials is known as an activator. Activators can be additives, for instance sulphate or calcium (hydr)oxide, and/or products of the hydraulic reaction of the cement; for example, as calcium silicates harden, they release calcium hydroxide, which acts as an activator. In contrast, pozzolans or pozzolanic materials are natural or industrially-produced substances, for example lime-deficient fly ashes which contain reactive SiO₂ alone or in combination with Al₂O₃ and/or Fe₂O₃, but which are not capable of hardening with water on their own by forming calcium(aluminium) silicate hydrate and/or calcium aluminate(ferrate) phases. Pozzolans contain either no or only very little CaO. In contrast to latent hydraulic materials, they therefore require CaO or Ca(OH)₂ to be added in order for a hydraulic hardening based on the formation of calcium silicate hydrates to take place. The supplementary cementitious material or SCM itself can also constitute a hydraulic material if it contains sufficient quantities of free lime and periclase and/or reactive clinker phases together with pozzolanic or latent hydraulic materials. In actual practice the borders among hydraulic, latent hydraulic, and pozzolanic materials are often blurred; for example, fly ashes can often be anything from pozzolanic, latent hydraulic, to hydraulic materials, depending on the mineralogy and the calcium oxide content. By SCM are meant latent-hydraulic as well as pozzolanic materials. A distinction must be made between SCMs and non-reactive mineral additives such as rock flour, which do not play any role in the hydraulic conversion of the binder. In the literature, SCMs are sometimes grouped together with such additives as mineral additives.

A clinker can already contain all necessary or desired phases and can be used directly as a binder after having been ground into cement. The composition of the binder is often obtained by mixing cement and other constituents, according to the invention at least the supplementary cementitious material, and two or a plurality of clinkers and/or cements are also possible. Mixing already takes place before (or during) grinding and/or in the ground state and/or during the production of the binder. Unless explicit mention is made of a time point for the mixing, the following descriptions relate to binders (and cements) that are not limited in this respect.

According to the invention, an SCM is obtained by burning the mixture containing aluminium silicate and dolomite. A (highly) reactive SCM is thus obtained or even a clinker is generated from otherwise unexploitable or poorly exploitable materials that in the past were hardly of any use as construction materials. The substitution of cement clinker results in savings in terms of raw materials for producing the same and above all energy, since the SCMs of the invention require lower burning temperatures than cement clinkers for Portland cement or calcium sulphoaluminate cement.

Another surprising advantage is the rapid conversion of the MgO contained in the SCM according to the invention. The MgO is usually fully hydrated within the first 1 to 7 days, and after at most 28 days either no MgO or only traces (<1%) thereof are detectable. The material can also be adjusted such that autogenous shrinkage is at least partially offset by the conversion and volume increase of MgO to Mg(OH)₂ and a potential formation of shrinkage cracks is minimized or prevented. This process initiates in the first days of hydration and concludes at the latest with the complete conversion of MgO.

Calculated on a loss on ignition-free (LOI-free) basis, the starting material should preferably contain at least 10 wt % MgO and at least 15 wt % Al₂O₃. At least 12 wt % MgO is particularly preferably contained, wherein the (main) fraction of the MgO comes from the dolomite constituent, i.e. should be present as carbonate. At least 15 wt % Al₂O₃, in particular at least 20 wt % Al₂O₃, are contained. Furthermore, at least 15 wt % SiO₂, preferably at least 25 wt % SiO₂, and in particular at least 40 wt % SiO₂ should be contained.

For the sake of simplicity, mention shall be made of starting material, wherein this term encompasses materials created by mixing as well as materials that naturally contain the desired constituents in the needed amounts. Use is made of a mixture if a starting material does not contain the desired quantities of MgO, Al₂O₃ and SiO₂. As a rule, starting materials that contain 40 to 80 wt %, preferably 50 to 70 wt %, and in particular 55 to 65 wt % aluminium silicate constituents as well as from 20 to 60 wt %, preferably 30 to 50 wt %, and in particular 35 to 45 wt % dolomite constituents are well suited.

The weight ratio of Al₂O₃+SiO₂ to MgO+CaO of the starting material is preferably in the range of 0.7 to 6, more preferably in the range of 1.1 to 4, and in particular in the range of 1.5 to 2.9. In other words, in contrast to the raw material mixtures used for Roman cement, which as a rule use raw materials with a weight ratio of Al₂O₃+SiO₂ to CaO(+MgO) of <0.5, there should preferably be more aluminium silicate than dolomite in the starting material for the method according to the invention.

In the context of this invention, dolomite constituent means a material that contains calcium magnesium carbonate (CaMg(CO₃)₂). Materials with a calcium magnesium carbonate content of at least 20 wt %, in particular >50 wt %, and most preferably >80 wt % are suitable. Hence particular preference is given to the carbonate minerals dolomite and dolomitic limestone. Moreover, the dolomite constituents can contain other carbonates such as, e.g., magnesite, barringtonite, nesquehonite, lansfordite, hydromagnesite, calcite, vaterite, ankerite, huntite, and aragonite. All materials of natural or synthetic origin that contain calcium magnesium carbonate in suitable quantities are suitable as dolomite constituent. In addition to calcium magnesium carbonate, preference is given to Mg- and/or Ca-containing carbonates that convert in the temperature range of 600 to 1000° C., preferably 700 to 950° C.

It is particularly favourable if the decomposition or rather conversion temperature, respectively, of the dolomite constituent is adjusted to that of the aluminium silicate constituent. Hence it is favourable if the decomposition or rather conversion temperatures, respectively, are approximately in the same range. For example, the decomposition/conversion of the dolomite constituent should take place at the same temperature or at a temperature up to 50° C. higher or preferably lower than that of the aluminium silicate constituent.

In the context of the invention, aluminium silicate refers to minerals and synthetic materials that contain Al₂O₃ and SiO₂. Minerals, natural by-products and waste products, and also industrial by-products and waste products that provide SiO₂ and Al₂O₃ in sufficient quantities and are at least partially hydrated and/or carbonated are suitable as aluminium silicate constituents. Calculated on a loss on ignition-free basis, the aluminium silicate constituents should contain more than 12 wt % Al₂O₃, preferably at least 20 wt % Al₂O₃, in particular at least 30 wt % Al₂O₃, as well as 25 to 65 wt % SiO₂, preferably 35 to 55 wt % SiO₂ and in particular between 40 and 50 wt % SiO₂. Loss on ignition-free (LOI-free) refers to samples that were calcined at 1050° C. The aluminium silicate constituent typically contains representatives of various minerals such as, but not limited to, ones from the group of clays, micas, amphiboles, serpentines, carpholites, staurolites, zeolites, allophanes, topazes, feldspars, Al- and Fe-containing hydroxides, and other natural pozzolans, laterites and saprolites. Use can also be made of aluminium silicate constituents with more than 40 wt % Al₂O₃. Particular preference is given to using low quality materials, i.e. ones that are not suited or else only poorly suited for other purposes (like as “calcined clay” produced as an SCM according to the current prior art). Low quality material refers to aluminium silicates such as pozzolans and clays, which cannot be activated in sufficient quantity by a burning process in order to satisfy, for example, the quality requirements as defined for, e.g., fly ashes in EN 450-1. Low quality material is furthermore understood to mean materials consisting of complex mineral mixtures in which phases with markedly different optimum calcination temperatures occur together, for example. These materials are often a mix of phases, for example of different clay minerals, micas, and including, but not exclusively, other natural aluminium silicates and aluminium hydroxides with in part very different optimum temperatures for calcination. Where appropriate, use can also be made of synthetic starting materials provided that they have comparable compositions and properties. Furthermore, it was surprisingly found that even for materials of adequate quality (materials that constitute reactive pozzolans, either naturally or as a result of heat treatment in the temperature range of 600 to 900° C., and thus fulfil the criteria as defined in, e.g., EN 450-1 for fly ashes), the reactivity can be improved by the method according to the invention.

Particular preference is given to clay and clay-containing materials as aluminium silicate constituents. In the context of the invention, by clay and clay-containing materials is meant materials that contain predominantly clay minerals, i.e. layered silicates with layers of SiO₄ tetrahedra and layers of AlO₆ octahedra. The tetrahedral and octahedral layers typically have other elements that are partially substituted for Si and/or Al. As a rule clay and clay-containing materials are fine particle to ultra-fine particle materials with particle sizes <4 μm or <2 μm or <1 μm. However, this is not mandatory in the context of the invention; chemically and mineralogically equivalent materials with larger particle sizes can also be used. Clays can contain other materials, and clay-containing materials do contain such materials. In particular clays, clay-containing materials, and synthetic materials of similar structure which contain very different phases and which are either not reactive or else insufficiently reactive profit from the invention.

In addition to mixtures of aluminium silicate constituents and dolomite constituents as described above, possible starting materials include marls (mixtures of clay and limestone/dolomite). As long as the latter have a sufficient content of MgO bound as carbonate, they are suitable as the sole raw material. On the other hand, marls with a high CaO content should be used only in small quantities so that the CaO content in the starting material, calculated on a loss on ignition-free basis, is as low as possible. Preferred are up to 40 wt % in particular <30 wt %, and particularly preferred <20 wt %.

Without wishing to be bound to this hypothesis, it is assumed that at calcination, dolomite and similarly composed materials are decomposed at lower temperatures than, e.g., limestone, and, thus, reactive silicates, and aluminates can therefore can be made from silicon as well as aluminium, so that either no or fewer inert crystalline phases (mullite, for example) form.

The temperature during burning ranges from >800 to 1100° C.; the mixture is preferably burned at 825 to 1000° C., particularly preferred at 850 to 975° C. In contrast to the calcination of clays according to the prior art (in which maintaining a narrow temperature range is mandatory), very broad temperature ranges, including very high temperatures (>900° C.), can be used. Even at these high temperatures, the SCM still shows a very high reactivity, and surprisingly the highest reactivity to some extent.

If necessary, before burning the starting material can be ground and, in the case of starting material mixtures, thoroughly mixed by being ground together, for example. However, it is also possible to use just crushed material. A starting material fineness of 2000 to 10,000 cm²/g (Blaine), preferably 3000 to 7000 cm²/g, has proven advantageous. Particle sizes (laser granulometry) ranging from a d₉₀<200 μm, preferably d₉₀<100 μm, and particularly preferably d₉₀<60 μm were well-suited. As any person skilled in the art knows, greater finenesses permit a more effective calcination (e.g., reduced burning temperature and/or reduced residence time und an increased phase conversion). However, the grinding of such complex mixtures (very soft materials (e.g., clay) with very hard materials (e.g., quartz)) is very difficult, and frequently also leads to problems in the use as SCM due to, for example, the considerably increased water demand. A particular advantage of the invention is the considerably increased flexibility towards higher temperatures. Even (very) coarse material is sufficiently converted, and the specific surface, and accordingly the water demand, is reduced considerably by the high burning temperatures (e.g., >900° C.).

All standard devices are suitable for burning, examples of which include, but are not limited to, directly or indirectly fired rotary kilns, fluidized-bed reactors, shaft kilns and multiple hearth ovens, and “flash calciners”.

The conversion in devices such as, but not limited to, rotary kilns or shaft kilns and multiple hearth ovens typically requires 5 to 240 minutes, preferably 25 to 120 minutes, and in particular 40 to 75 minutes and should be adjusted according to the device, the burning temperature, and the desired product characteristics. At higher temperatures, shorter times can also be advantageous if, for example, phases that will be destroyed at lower temperatures (e.g., kaolinite) predominate.

The conversion in devices such as, but not limited to, fluidized-bed reactors or flash calciners typically requires 5 to 300 seconds, preferably 10 to 150 seconds, and in particular 20 to 100 seconds and should be adjusted according to the device, the burning temperature, and the desired product characteristics.

It is possible to lower the required temperature by adding one or several mineralisers, including but not limited to borax, waste glass, iron salts (e.g., sulphates, hydroxides, carbonates, fluorides, nitrates, or mixtures thereof), alkaline salts (e.g., sulphates, hydroxides, (bi)carbonates, fluorides, or mixtures thereof) and/or alkaline earth salts (e.g., sulphates, hydroxides, (bi)carbonates, fluorides, or mixtures thereof). The temperature to use then lies in the range of 725 to 950° C., preferably 775 to 900° C., in particular 800 to 875° C. Typically, ≦4 wt %, preferably ≦3 wt % and particularly preferred ≦2 wt % mineralisers are added. Impurities in the raw materials often suffice.

The mineralisers are selected such that they promote the formation of reactive phases. These include clinker phases such as N_{y}C_{4-y}A₃₋ₓFₓ$, CA, C₁₂A₇, C₃A, C₂S; reactive (calcium) alkaline sulphates such as K₂Ca₂(SO₄)₃, K₂SO₄, Na₂Ca(SO₄)₂, Na₂SO₄, K₃Na(SO₄)₂ and calcium sulphate; as well as inert, magnesium-containing minerals in which magnesium oxide (released during dolomite decomposition) is bound, such as magnesium (aluminium, iron) silicates (e.g., forsterite, enstatite, spinel, etc.).

According to the invention, an important effect of the burning, particularly at temperatures above 800° C., preferably above 900° C., is a substantial reduction of the surface area of the aluminium silicate constituent. Through burning, the specific surface area (measured BET in m²/g) decreases by at least 15%, preferably by at least 20%, and in particular by 30%. 40% or 50% reduction is often achieved, in some cases even more. By reducing the surface area, the adsorption and absorption of water and admixtures, respectively, are lowered. As a result the water demand, i.e. the volume of water needed for achieving the desired fluidity, and the amounts of admixtures required, decrease.

After burning, the supplementary cementitious material obtained is typically cooled. It can be cooled rapidly in order to prevent a phase transformation or crystallization, for example. Normally, rapid cooling is not mandatory. The product is a sintered product in which the starting material has been at least partially, preferably at least 10%, and in particular at least 20% melted or mineralogically transformed. The phases differ from those of the starting material, since calcium silicates and aluminates as well as diverse magnesium compounds, for example can form, depending on the chemistry and the burning temperature. Meanwhile, a large portion of the mineralogically transformed phase content can also occur in x-ray amorphous form.

In contrast, the term calcination refers to a burning below the sintering temperature, in which solids and mineral powders such as clays or limestones, for example, are dehydrated, deacidified (release of CO₂), and/or decomposed by heating. The dehydration and decomposition give rise to, for example, pozzolanic materials such as metakaolin as products. Al₂O₃ and SiO₂ are present mostly in unbound form (“free” Al₂O₃ and SiO₂) in these materials. Excessively high temperatures or excessively long residence times can lead to sintering, which in the case of clay results in the formation of new mineral phases such as mullite (e.g., Al₍₄₊₂ₓ₎Si₍₂₋₂ₓ₎O₍₁₀₋ₓ₎, wherein x is from 0.17 to 0.59). This is accompanied by a substantial decline in reactivity, which may ultimately lead to a material that is no longer reactive. The calcination (deacidification) of carbonates gives rise to metal oxides such as CaO and MgO as decomposition products. Accordingly, the combined calcination of, for example, kaolin and limestone or dolomite gives rise to metakaolin, free lime, and if applicable periclase.

The term sintering is understood to mean a process which often follows calcination. Higher burning temperatures, or also prolonged residence times, lead to a reaction between oxide constituents (e.g., CaO or MgO with Al₂O₃, Fe₂O₃ and/or SiO₂) and to the formation of new, often more reactive mineral phases. The mineral phases can be present partially (up to 10%) to nearly entirely (>90%) in an x-ray amorphous form, which is attributable to the small crystallite sizes or also to a low degree of crystallinity. By selectively optimizing the raw material mixture (e.g., addition of mineralisers or corrective substances such as Al₂(SO₄)₃, Fe₂(SO₄)₃, CaSO₄, Na₂SO₄, etc.) and the process conditions (e.g., material fineness, temperature, residence time), it is possible to create mineral sintered products such as ye'elimite, temesite, belite, mayenite, ferrite, etc. Via the steps described, it is furthermore desired and possible to promote the formation of a melt phase, i.e. to use a combination of solid phase sintering and fluid phase sintering. Accordingly, the combined sintering of, e.g., kaolin and limestone or dolomite gives rise to diverse new mineral phases (e.g., calcium aluminates, calcium silicates, calcium sulphoaluminates, calcium sulphosilicates, magnesium silicates, magnesium ferrites, magnesium aluminates, as well as diverse mixed crystals) and potentially a melt phase. The pozzolan metakaolin, free lime, and periclase may also be present.

For use, the supplementary cementitious material is generally ground to a fineness of 2000 to 10,000 cm²/g (Blaine), preferably 3500 to 8000 cm²/g, and particularly preferably 3500 to 8000 cm²/g. The grinding can be carried out separately or together with the other cement and binder constituents. Combined grinding has proven especially suitable.

The specific surface area of the ground supplementary cementitious material is typically at a d₉₀<150 μm, preferably at a d₉₀<90 μm, and particularly preferably at a d₉₀<60 μm.

The final binder is present in typical cement finenesses, according to the production.

Preference is given to using grinding aids in the grinding of the raw powder mixture and/or of the supplementary cementitious material. The grinding aids are preferably, but not exclusively, chosen from the group of glycols and alkanolamines, in particular but not exclusively diethanolisopropanolamine (DEIPA), triisopropanolamine (TIPA), and/or triethanolamine (TEA), and also from the group of alkyl dialkanolamines such as methyl diisopropanolamine, as well as mixtures thereof.

The supplementary cementitious material according to the invention can (like fly ash and granulated blast furnace slag, for example) be used as an SCM.

To this end, it is combined with cement to form a binder. The supplementary cementitious material and the cement can be ground separately or together, with or without sulphate. The binder can furthermore contain admixtures and/or additives, which are known per se and are used in the standard amounts.

Particular consideration is given to Portland cement and calcium sulphoaluminate cement as a cement. Use can also be made of calcium aluminate cement. The use of so-called geopolymer cements makes little sense economically. As a rule Portland cement, also known as OPC, comprises from 50 to 70 wt % C₃S, from 10 to 40 wt % C₂S, from 0 to 15 wt % C₃A, from 0 to 20 wt % C₄AF, from 2 to 10 wt % C$-xH, from 0 to 3 wt % C, and from 0 to 5 wt % Cc (CaCO₃). As a rule the chemical composition is 55-75 wt % CaO, 15-25 wt % SiO₂, 2-6 wt % Al₂O₃, 0-6 wt % Fe₂O₃, and 1.5-4.5 wt % SO₃. As a rule calcium sulphoaluminate cement, also known as CSA or C$A, contains from 10-75 wt % C₄A₃$, from 5-30 wt % C$, from 0-30 wt % C₄AF, from 0-30 wt % calcium aluminate, and from 2-70 wt % C₂S and/or C₅S₂$. Depending upon the raw material mixture and the production conditions, variants such as belite-calcium sulphoaluminate cement (abbreviated BCSA or BCSAF) with an increased belite content of at least 10 or 20 wt % and ternesite (belite) calcium sulphoaluminate cement (abbreviated T(B)CSA or T(B)CSAF) with a content of 5 to >50 wt % C₅S₂$ can be obtained in a targeted manner, depending on the raw material mixing and the production conditions.

Using 1 to 90 wt %, preferably 10 to 70 wt %, and in particular 20 to 50 wt % cement and 10 to 99 wt %, preferably 30 to 90 wt %, and in particular 50 to 80 wt % SCM according to the invention in the binder has proven effective. In addition, the binder preferably contains up to 10 wt %, particularly preferably 1 to 7 wt %, and in particular 2 to 5 wt % sulphate carrier.

The sulphate carrier is preferably mostly or exclusively calcium sulphate or a mixture of calcium sulphates.

Admixtures can also be added to the binder, preferably during processing, either in the amounts known per se or in amounts necessary for compensating remaining adsorption or absorption.

For example, one or several setting and/or hardening accelerators, preferably chosen from aluminium salts and aluminium hydroxides, calcium (sulpho) aluminates, lithium salts and lithium hydroxides, other alkaline salts and alkaline hydroxides, alkaline silicates, and mixtures thereof can be contained, in particular chosen from Al₂(SO)₃, AlOOH, Al(OH)₃, Al(NO₃)₃, CaAl₂O₄, Ca₁₂Al₁₄O₃₃, Ca₃Al₂O₆, Ca₄Al₆O₁₂(SO₄), LiOH, Li₂CO₃, LiCl, NaOH, Na₂CO₃, K₂Ca₂(SO₄)₃, K₃Na(SO₄)₂, Na₂Ca(SO₄)₃, K₃Na(SO₄)₂, K₂Ca(SO₄)₂*H₂O, Li₂SO₄, Na₂SO₄, K₂SO₄, KOH and water glass.

It is further preferred if concrete plasticizers and/or water reducing agents and/or retarders are contained. Examples of suitable ones include those based on lignin sulphonates; sulphonated naphthalene, melamine, or phenol-formaldehyde condensate; or ones based on acrylic acid-acryl amide mixtures or polycarboxylate-ethers or ones based on phosphated polycondensates; based on phosphated alkyl carboxylic acids and salts thereof; based on (hydroxy-) carboxylic acids and carboxylates, in particular citric acid, citrates, tartaric acid, tartrates; borax, boric acid and borates, oxalates; sulphanilic acid; amino-carbonic acids; salicylic acid, and acetylsalicylic acid; dialdehydes and mixtures thereof.

The binder can furthermore contain additives, e.g., rock flour, in particular limestone and/or dolomite, precipitated (nano) CaCO₃, magnesite, pigments, fibres, etc. In addition, SCMs known per se, in particular granulated blast furnace slag, fly ash, SiO₂ in the form of silica fume, microsilica, pyrogenic silica, etc., can be contained. The total amount of these additives is preferably up to 40 wt %, preferably 5 to 30 wt %, and particularly preferred 10 to 20 wt %.

Obviously the sum of all constituents in a mixture, e.g., in a binder or in a starting material, always equals 100 wt %.

If it possesses latent hydraulic properties, the supplementary cementitious material can also be combined with an activator to form a cement. Similarly to granulated blast furnace slag, the supplementary cementitious material can hydraulically harden like cement when its latent hydraulic properties are activated.

In contrast to binders known as Roman cement, the supplementary cementitious material according to the invention aims at aluminium- and/or silicon-containing hardening phases. Accordingly, it is logical to use aluminium- and/or silicon-releasing constituents as activators, examples of which include, but are not limited to Al₂(SO₄)₃, Al(OH)₃, and calcium aluminates such as CA, C₃A, and C₁₂A₇, and furthermore nano- or microsilica, water glass, and mixtures thereof.

The activator or activators are used in amounts ranging from 0.1 to 5 wt %, preferably from 0.5 to 3 wt %, and particularly preferred from 1 to 2 wt %, based on the amount of the supplementary cementitious material.

Also with such a binder made of supplementary cementitious material and activator, admixtures and additives can be used in a manner known per se, as described above.

With the binders according to the invention containing cement and the supplementary cementitious material according to the invention, if need be it is furthermore possible to add an activator of the type and in the amount described above in order to achieve an accelerated reaction.

Construction materials such as concrete, mortar, screed, construction chemical compositions (e.g., tile adhesive, etc.) can be obtained from the binders. An advantage of the invention lies in the fact that supplementary cementitious material produced according to the invention is very reactive; construction materials produced therefrom have properties comparable to construction materials produced from Portland cement.

The invention also relates to all combinations of preferred embodiments, provided that they are not mutually exclusive. When “about” or “ca.” are used in connection with a numerical figure, this means that values that are at least 10% higher or lower, or values that are 5% higher or lower, and in any case values that are 1% higher or lower are included. Unless stated otherwise or the context dictates otherwise, percentages are based on the weight, in case of doubt on the total weight, of the mixture.

The invention shall be illustrated on base of the following examples, but without being limited to the specifically described embodiments.

In the examples, three different clays and a pozzolan as an aluminium silicate constituent were used and, with dolomite and perhaps other additions added, burned at different temperatures. The products were used as SCM in order to determine the reactivity. For this purpose, binders were produced which contained 56.5 wt % Portland cement (OPC) clinkers, 3.5 wt % anhydrite, and 40 wt % of a supplementary cementitious material or for comparison 40 wt % limestone, and the compressive strength was determined according to EN 196 after 7 and 28 days. Deviating from the standard, the binder was mixed with a fine sand in a 2:3 ratio, and a water-cement ratio of 0.55 was used. Compressive strength was measured on cubes with an edge length of 20 mm and a feed rate of 400 N/s. All supplementary cementitious materials and the limestone were ground with the same grinding energy in order to make the results comparable. The processability (flow properties and water demand) was comparable for all supplementary cementitious materials.

The starting materials had the oxide compositions (LOI 1050=loss on ignition at 1050° C.) and N₂-BET surface areas (untreated starting material) given in Table 1, which follows:

TABLE 1

| | An- | | | | | | | |
|---|---|---|---|---|---|---|---|---|
| | hydrite | Clinker | Limestone | Dolomite | Pozzolan | Clay 1 | Clay 2 | Clay 3 |
| LOI 1050 | 3.68 | 0.29 | 42.57 | 46.73 | 5.37 | 7.90 | 21.42 | 12.94 |
| SiO₂ | 2.04 | 20.86 | 1.75 | 0.18 | 59.77 | 54.25 | 36.42 | 47.73 |
| Al₂O₃ | 0.60 | 4.88 | 0.46 | 0.07 | 19.62 | 19.23 | 11.08 | 28.86 |
| TiO₂ | 0.03 | 0.37 | 0.02 | 0.00 | 0.69 | 0.82 | 0.49 | 1.04 |
| MnO | 0.00 | 0.05 | 0.02 | 0.00 | 0.12 | 0.16 | 0.08 | 0.00 |
| Fe₂O₃ | 0.23 | 3.67 | 0.20 | 0.03 | 7.22 | 6.82 | 6.75 | 8.15 |
| CaO | 38.32 | 63.52 | 53.93 | 32.71 | 2.50 | 2.76 | 16.15 | 0.03 |
| MgO | 1.45 | 2.57 | 0.55 | 18.99 | 1.22 | 2.45 | 3.63 | 0.26 |
| K₂O | 0.16 | 1.09 | 0.07 | 0.01 | 1.51 | 3.18 | 1.11 | 0.49 |
| Na₂O | 0.00 | 0.55 | 0.00 | 0.00 | 1.75 | 0.83 | 0.17 | 0.02 |
| SO₃ | 52.24 | 1.22 | 0.03 | 0.00 | 0.00 | 0.48 | 0.11 | 0.00 |
| P₂O₅ | 0.02 | 0.26 | 0.04 | 0.01 | 0.07 | 0.13 | 1.55 | 0.08 |
| Sum | 98.76 | 99.34 | 99.65 | 98.74 | 99.83 | 99.00 | 98.96 | 99.60 |
| BET [m²/g] | | | | | 24.93 | 15.3 | 38.55 | 42.11 |

The phase compositions of the aluminium silicate constituents were determined using x-ray diffractometry (XRD) and then verified using thermal gravimetric analysis (TGA). The XRD results are given in Table 2. The “Clay 2” material is a clay (almost exclusively palygorskite and kaolin) contaminated with limestone, which strictly speaking would be classified as marl. Such a material has already been used, for example in Tobias Danner, “Reactivity of calcined clays”, ISBN 978-82-471-4553-1.

The classification (main and minor phases, traces) was estimated and is not a quantitative determination. A majority of the sample was in the form of an x-ray amorphous fraction. A precise quantification/determination of the phase composition of such complex systems is extremely difficult.

TABLE 2

| | Pozzolan | Clay 1 | Clay 2 | Clay 3 |
|---|---|---|---|---|
| Main phases | Kaolinite | IIlite | Calcite | Kaolinite |
| | Anorthite | Quartz | Quartz | Quartz |
| Minor phases | Cristobalite | Clinochlore | Montmorillonite | Goethite |
| | Sanidine | Muscovite | Palygorskite | Montmorillonite |
| Traces | Montmorillonite | Kaolinite | Hematite | IIlite |
| | Quartz | Montmorillonite | Kaolinite | Opal |
| | Tridymite | Albite | | |
| | Opal | Microcline | | |
| | Albite | Ankerite | | |
| | Microcline | | | |
| | Haematite | | | |

### EXAMPLE 1

As a low quality aluminium silicate constituent (very complex mixture of phases that are destroyed in substantially different temperature ranges (600 to 1000° C.)), use was made of Clay 1, which was burned at 825° C. Table 3 lists the supplementary cementitious materials tested and the results.

TABLE 3

| | Compressive | |
|---|---|---|
| | strength | |
| | [MPa] after | |
| supplementary cementitious material | 7 d | 2d |
| 100% limestone (unburned) | 25.1 | 31.1 |
| 50% clay + 50% limestone (only clay burned) | 25.1 | 29.2 |
| 50% clay + 50% dolomite (burned together) | 22.6 | 34.5 |
| 66% clay + 34% dolomite (burned together) | 26.4 | 38.6 |
| 66% clay + 34% dolomite (burned separately) | 22.3 | 35.5 |
| 50% clay + 50% dolomite + alkali (burned together) | 27.5 | 39.4 |
| 66% clay + 34% dolomite + alkali (burned together) | 27.1 | 42.3 |
| 66% clay + 34% dolomite (burned separately) + | 22.4 | 31.6 |
| alkali in the mixing water | | |

It is apparent that the method according to the invention provides a reactive supplementary cementitious material from a very poor quality clay; Clay 1 contains large quantities of mica and quartz, but hardly any kaolinite. In spite of the unsuitable composition (50:50) of the starting material, a 10% higher compressive strength was achieved compared to the comparison standard with limestone. With regard to the combination of limestone and separately burned clay proposed in the prior art, the supplementary cementitious material according to the invention is significantly more reactive (9 to 32% greater compressive strength). The addition of 1 wt % NaHCO₃ as a mineraliser during burning further optimizes the reactivity. This effect is not achieved if the alkalis are added to the mixing water instead. The comparison to clay and dolomite burned separately from each other illustrates the synergistic effect of burning them in combination. Also evident is the substantial improvement compared to the use of so-called Roman cement. It is evident that increasing contents of Clay 1 (see 50:50 to 66:34 comparison) lead to a substantial increase in strength development and that strength development is therefore not attributable (or at least only partially) to the reaction of burned lime or dolomite (as in the case with Roman cement). Instead the strength development is attributable to the contribution of reactive clinker phases (e.g., C₃A, CA, C₁₂A₇, C₂S and C₄A₃$), occurring partially in x-ray amorphous form, obtained by the method of the invention, as well as to a pozzolanic reaction. A clay:dolomite weight ratio of 2:1 proved to be particularly favourable for Clay 1. With an ideal starting material mixture and mineralisers, according to the invention a clay that is otherwise unusable as an SCM can be used in a very advantageous manner.

### EXAMPLE 2

The influence of burning temperature was investigated, wherein in each case 1:1 mixtures of Clay 1 and dolomite were compared to the mixtures of Clay 1 and limestone as the prior art standard. The results are summarized in Table 4.

TABLE 4

| | | Compressive | |
|---|---|---|---|
| | | strength | |
| | Burning | [MPa] after | |
| supplementary cementitious material | temperature | 7 d | 28 d |
| 100% limestone (unburned) | ./. | 25.1 | 31.1 |
| 50% clay + 50% limestone | 825° C. | 25.1 | 29.2 |
| (only clay burned) | | | |
| 50% clay + 50% dolomite | 825° C. | 24.6 | 34.5 |
| (burned together) | | | |
| 50% clay + 50% limestone | 950° C. | 23.7 | 32.4 |
| (only clay burned) | | | |
| 50% clay + 50% dolomite | 950° C. | 25.4 | 39.1 |
| (burned together) | | | |

These results confirm that in contrast to the prior art, with the method according to the invention the higher burning temperature is not critical and even leads to better results. Furthermore, a substantial reduction of the water demand is to be expected with higher burning temperatures (see Example 5).

### EXAMPLE 3

Clay 2, which has calcite and quartz as crystalline main phases, was investigated. On the basis of the clay(s) that it contains (almost exclusively palygorskite and kaolin (dehydroxylation or decomposition in comparable temperature ranges)), this material is deemed high quality. Owing to the high CaCO₃ fraction, Clay 2 should actually be classified as marl. The burning temperature was also varied in this example. The supplementary cementitious materials studied and the results are presented in Table 5.

TABLE 5

| | | Compressive | |
|---|---|---|---|
| | | strength | |
| | Burning | [MPa] after | |
| supplementary cementitious material | temperature | 7 d | 28 d |
| 100% clay (burned) | 825° C. | 26.8 | 46.1 |
| 50% clay + 50% limestone | 825° C. | 26.6 | 45.0 |
| (only clay burned) | | | |
| 50% clay + 50% dolomite | 825° C. | 33.9 | 53.5 |
| (burned together) | | | |
| 50% clay + 50% dolomite | 825° C. | 25.3 | 41.2 |
| (burned separately) | | | |
| 100% clay (burned) | 950° C. | 19.6 | 27.7 |
| 50% clay + 50% limestone | 950° C. | 22.8 | 32.9 |
| (only clay burned) | | | |
| 50% clay + 50% dolomite | 950° C. | 31.0 | 47.3 |
| (burned together) | | | |
| 50% clay + 50% dolomite | 950° C. | 23.1 | 34.6 |
| (burned separately) | | | |

The experiments demonstrate the lack of sensitivity of the method according to the invention to different burning temperatures, in contrast to the burning of pure Clay 2 (prior art). It was furthermore confirmed that an increased reactivity was achieved compared to the clay-limestone mixtures as described in, e.g., Danner, “Reactivity of Calcined Clays”. Also worth mentioning is the accelerated reaction of the composite binder for the SCM according to the invention, which is quite evident from the 7 d compressive strengths. It turns out that compared to the prior art, even a material that is already high quality per se can be further improved.

### EXAMPLE 4

Clay 3 was studied, which has kaolin and quartz as crystalline main phases. On the basis of the clay(s) that it contains (almost exclusively kaolin and only a little illite and montmorillonite), this material is deemed high quality. The burning temperature was also varied in this example. The supplementary cementitious materials studied and the results are presented in Table 6.

TABLE 6

| | | Compressive | |
|---|---|---|---|
| | | strength | |
| | Burning | [MPa] after | |
| supplementary cementitious material | temperature | 7 d | 28 d |
| 100% clay (burned) | 825° C. | 30.5 | 45.0 |
| 50% clay + 50% limestone | 825° C. | 38.5 | 51.8 |
| (only clay burned) | | | |
| 50% clay + 50% dolomite | 825° C. | 48.2 | 55.5 |
| (burned together) | | | |
| 100% clay (burned) | 950° C. | 21.8 | 39.6 |
| 50% clay + 50% dolomite | 950° C. | 41.7 | 56.1 |
| (burned together) | | | |

The experiments demonstrate the lack of sensitivity of the method of the invention to different burning temperatures, in contrast to the burning of pure Clay 3 (prior art). Also worth mentioning is the accelerated reaction of the composite binder for the SCM according to the invention, which is quite evident from the 7 d compressive strengths. It turns out that compared to the prior art, even a material that is already high quality per se can be further improved.

### EXAMPLE 5

The effect of the method according to the invention on a low quality pozzolanic material unsuitable as a supplementary cementitious material was studied. The pozzolan (pozzo.) has a very complex mixture of phases that are destroyed in substantially different temperature ranges and is therefore deemed an inferior quality material. The burning temperature was varied here as well. The results are shown in Table 7.

TABLE 7

| | | Compressive | |
|---|---|---|---|
| | | strength | |
| | Burning | [MPa] after | |
| supplementary cementitious material | temperature | 7 d | 28 d |
| 50 wt % pozzolan + 50 wt % limestone | ./. | 23.7 | 31.8 |
| 50% pozzo. + 50% limestone | 825° C. | 26.5 | 39.7 |
| (only pozzo. burned) | | | |
| 100 wt % pozzo. (burned) | 825° C. | 23.4 | 39.6 |
| 50% pozzo. + 50% dolomite | 825° C. | 32.0 | 45.0 |
| (burned together) | | | |
| 66% pozzo. + 34% dolomite | 825° C. | 33.4 | 49.9 |
| (burned together) | | | |
| 66% pozzo. + 34% dolomite | 825° C. | 32.1 | 43.8 |
| (burned separately) | | | |
| 50% pozzo. + 50% limestone | 950° C. | 24.4 | 34.9 |
| (only pozzo. burned) | | | |
| 100 wt % pozzo. (burned) | 950° C. | 20.2 | 32.9 |
| 50% pozzo. + 50% dolomite | 950° C. | 27.1 | 38.4 |
| (burned together) | | | |
| 50% pozzo. + 50% dolomite | 950° C. | 24.8 | 34.7 |
| (burned separately) | | | |

The unburned pozzolan does not contribute to the development of compressive strength after 28 d. Furthermore, the pozzolan alone reacts very clearly to the degree of the burning temperature. If the temperature is increased from 825° C. to 950° C., the material makes nearly the same strength contribution as the untreated pozzolan (comparable to the 100% limestone reference standard). However, high temperatures are needed in order to convert all of the material present and in order to achieve the least possible surface area and thus a low water demand, as well as the destruction of all unwanted phases (e.g., swellable clays such as montmorillonite) in the binder. The supplementary cementitious material according to the invention is more reactive than the comparable prior art pozzolan-limestone mixture in each case, and a reactive SCM is obtained with the method according to the invention even at high temperatures. The comparison to pozzolan and dolomite burned separately from each other clearly shows the synergistic effect of burning them in combination.

### EXAMPLE 6

In order to show the influence of the burning temperature on the surface area of different clays, the specific surface area was determined before and after burning by means of gas absorption and desorption (BET). The results summarized in Table 8 were achieved for the clayey, pozzolanic starting materials:

TABLE 8

| | BET surface area in m²/g | | | | |
|---|---|---|---|---|---|
| | Before | | | | |
| Clay | burning | 525° C. | 700° C. | 825° C. | 950° C. |
| Pozzolan | 24.9 | — | 15.6 | 13.5 | 7.1 |
| Clay 1 | 15.3 | 14.6 | 14.5 | 6.4 | 1.8 |
| Clay 2 | 38.6 | 29.3 | 26.2 | 9.4 | 1.9 |
| Clay 3 | 42.1 | 41.4 | 41.8 | 31.5 | 24.1 |

In order to achieve the least possible surface area, the burning temperature should clearly be as high as possible. A small surface area is advantageous because the water demand becomes less as a result and the absorption of admixtures is also prevented or at least reduced. According to the prior art, however, a high burning temperature results in a material that has only limited use as an SCM, as can be inferred from Examples 1 through 4. As shown in the preceding examples, according to the invention it is possible to increase the burning temperature without sacrificing the reactivity as an SCM. By doing so the surface area can be reduced to a greater extent than in the prior art, and with some clays a greater fraction can be converted, with the reactivity increasing as a result.

### EXAMPLE 7

The conversion of clay with dolomite was compared to that of clay with Ca(OH)₂+Mg(OH)₂ as individual constituents. To this end, 1 part dolomite and as much of a mixture of Ca(OH)₂ and Mg(OH)₂ as needed in order to obtain the same chemical composition after the burning process as for the conversion with dolomite were added in each case to 2 parts by weight of a pozzolanic material. Again, burning was carried out at two different temperatures. Table 9 summarizes the results.

TABLE 9

| | | Compressive | |
|---|---|---|---|
| | | strength | |
| | Burning | [MPa] after | |
| supplementary cementitious material | temperature | 7 d | 28 d |
| Pozzo. + dolomite | 825° C. | 33.4 | 49.9 |
| Pozzo. + Ca(OH)₂ + Mg(OH)₂ | 825° C. | 28.8 | 42.3 |
| Pozzo. + dolomite | 950° C. | 28.8 | 43.6 |
| Pozzo. + Ca(OH)₂ + Mg(OH)₂ | 950° C. | 22.8 | 32.8 |

The form in which the MgO was bound before burning is clearly a decisive factor. In both cases the supplementary cementitious material produced according to the invention with dolomite as the MgO source is more reactive than the one with calcium hydroxide and magnesium hydroxide as the MgO source.

1. A method for producing a supplementary cementitious material (SCM), comprising the steps:
providing a starting material containing an aluminium silicate constituent and a dolomite constituent, wherein a weight ratio of Al₂O₃+SiO₂ to MgO+CaO of the starting material is in a range of 0.7 to 6, and
converting the starting material to the supplementary cementitious material by burning the starting material to a sintered product in a temperature range of >800° C. to 1100° C. if no mineralizers are contained, and in a temperature range of 725° C. to 950° C. if mineralizers are contained.

2. The method according to claim 1, wherein the step of providing includes mixing and combined grinding of the dolomite constituent and the aluminium silicate constituent.

3. The method according to claim 2, wherein before or during the grinding, one or several grinding aids are added.

4. The method according to claim 1, wherein a mixture containing 40 to 80 wt % aluminium silicate constituent and 20 to 60 wt % dolomite constituent is used as the starting material.

5. The method according to claim 1, wherein the starting material, calculated on a loss on ignition-free basis, contains at least 10 wt % MgO, occurring as carbonate.

6. The method according to claim 1, wherein the starting material, calculated on a loss on ignition-free basis, contains at least 15 wt % Al₂O₃.

7. The method according to claim 1, wherein the starting material, calculated on a loss on ignition-free basis, contains at least 15 wt % SiO₂.

8. The method according to claim 1, wherein the starting material is burned for 5 to 240 minutes.

9. The method according to claim 1, wherein the starting material is burned in a fluidized-bed reactor or in a flash calciner for 5 to 300 seconds.

10. The method according to claim 1, wherein the supplementary cementitious material is ground to a fineness of 2000 to 10,000 cm²/g according to Blaine.

11. The method according to claim 10, wherein before or during grinding, one or several grinding aids are added, which are chosen from the group consisting of glycols, alkanolamines, alkyl dialkanolamines and mixtures thereof.

12. The method according to claim 1, wherein the starting material does not contain any mineralizers and is burned at 825° C. to 1000° C.

13. The method according to claim 1, wherein the starting material contains one or several mineralizers and is burned at 725° C. to 950° C.

14. The method according to claim 13, wherein the mineralizer or mineralizers is/are chosen from the group consisting of borax, waste glass, iron salts alkaline salts and/or alkaline earth salts.

15. A binder comprising:
at least one cement selected from the group consisting of Portland cement, calcium sulphoaluminate cement, and calcium aluminate cement, and
a ground supplementary cementitious material (SCM) produced according to the method of claim 1.

16. The binder according to claim 15, wherein an amount of cement is from 1 to 90 wt %, and an amount of supplementary cementitious material (SCM) is from 10 to 99 wt %.

17. The binder according to claim 15, further comprising an additional sulphate carrier.

18. The binder according to claim 17, wherein the sulphate carrier comprises from 0.1 to 10 wt % calcium sulphate or a mixture of calcium sulphates.

19. The binder according to claim 1, further comprising one or several setting accelerators, hardening accelerators, or both, chosen from the group consisting of aluminium salts and aluminium hydroxides, calcium (sulpho)aluminates, lithium salts and lithium hydroxides, other alkaline salts and alkaline hydroxides, alkaline silicates and mixtures thereof.

20. The binder according to claim 15, further comprising at least one activator to 19, characterized in that one or several activators are contained, preferably in an amount of 0.1 to 5 wt % based on the amount of the supplementary cementitious material (SCM).

21. The binder according to claim 15, further comprising one or more of the group consisting of concrete plasticizers, water reducing agents and retarders, and wherein the concrete plasticizers, reducing agents and retarders are based on lignin sulphonates; sulphonated naphthalene, melamine, or phenol formaldehyde condensate; or based on acrylic acid-acryl amide mixtures or polycarboxylate ethers, or based on phosphated polycondensates; phosphated alkyl carboxylic acids and salts thereof; (hydroxy-) carboxylic acids and carboxylates; borax, boric acid and borates, oxalates; sulphanilic acid; amino-carbonic acids; salicylic acid, and acetylsalicylic acid; dialdehydes and mixtures thereof.

22. The binder according to claim 15, further comprising additives selected from the group consisting of rock flour, precipitated (nano) CaCO₃, pigments, fibers, and mixtures of two or more thereof in an amount of up to 40 wt %.

23. The binder according to claim 15, further comprising one or more of the group consisting of granulated blast furnace slag, fly ash, SiO₂ in a form of silica fume, microsilica, and pyrogenic silica in an amount of up to 40 wt %.

24. The method according to claim 3, wherein the grinding aids are chosen from the group consisting of glycols, alkanolamines, alkyl dialkanolamines and mixtures thereof.

25. The method according to claim 4, wherein the mixture used as the starting material contains 50 to 70 wt % aluminium silicate constituent and 30 to 50 wt % dolomite constituent.

26. The method according to claim 4, wherein the mixture used as the starting material contains 55 to 65 wt % aluminium silicate constituent and 35 to 45 wt % dolomite constituent.

27. The method according to claim 5, wherein the starting material, calculated on a loss on ignition-free basis, contains at least 12 wt % MgO as carbonate.

28. The method according to claim 6, wherein the starting material, calculated on a loss on ignition-free basis, contains at least 20 wt % Al₂O₃.

29. The method according to claim 7, wherein the starting material, calculated on a loss on ignition-free basis, contains at least 25 wt % SiO₂.

30. The method according to claim 26, wherein the starting material, calculated on a loss on ignition-free basis, contains at least 10 wt % MgO as carbonate, at least 15 wt % Al₂O₃ and at least 15 wt % SiO₂.

31. The method according to claim 8, wherein the starting material is burned in a range of 25 to 120 minutes.

32. The method according to claim 10, wherein the supplementary cementitious material (SCM) is ground to a fineness according to Blaine of 3500 to 8000 cm²/g.

33. The method according to claim 12, wherein the starting material is burned in a temperature range of 850° C. to 975° C.

34. The method according to claim 13, wherein the starting material is burned at a temperature range of 775° C. to 900° C.

35. The method according to claim 26, wherein the starting material does not contain any mineralizers and is burned in a temperature range of 825° C. to 1000° C.

36. The method according to claim 26, wherein the starting material contains one or several mineralizers and is burned in a temperature range of 725° C. to 950° C.

37. The binder according to claim 15, comprising from 10 to 70 wt % cement and from 30 to 90 wt % supplementary cementitious material (SCM).

38. The binder according to claim 15, wherein the binder contains from 20 to 50 wt % cement and from 50 to 80 wt % supplementary cementitious material (SCM).

39. The binder according to claim 19, wherein the one or several setting accelerators, hardening accelerators or both, is/are chosen from the group consisting of Al₂(SO)₃, AlOOH, Al(OH)₃, Al(NO₃)₃, CaAl₂O₄, Ca₁₂Al₁₄O₃₃, Ca₃Al₂O₆, Ca₄Al₆O₁₂(SO₄), LiOH, Li₂CO₃, LiCl, NaOH, Na₂CO₃, K₂Ca₂(SO₄)₃, K₃Na(SO₄)₂, Na₂Ca(SO₄)₃, K₃Na(SO₄)₂, K₂Ca(SO₄)₂*H₂O, Li₂SO₄, Na₂SO₄, K₂SO₄, KOH, nanosilica and microsilica, water glass and mixtures thereof.

40. The binder according to claim 20, wherein the one or several accelerators is/are contained in an amount of 0.5 to 3 wt %, based on the amount of the supplementary cementitious material (SCM).

41. The binder according to claim 22, further comprising additives in an amount of 5 to 30 wt %.

42. The binder according to claim 23, further comprising one or more of the group consisting of granulated blast furnace slag, fly ash, SiO₂ in the form of silica fume, microsilica and pyrogenic silica, in an amount of 5 to 30 wt %.
